(19) United States
(12) Patent Application Publication
(10) Pub. No.: US 2010/0048410 A1
(43) Pub. Date: Feb. 25, 2010

(54) Bead Sorting on a Droplet Actuator

(75) Inventors: Alexander D. Shenderov, Raleigh, NC (US); Vamsee K. Pamula, Durham, NC (US); Allen E. Eckhardt, Durham, NC (US)

Correspondence Address: ADVANCED LIQUID LOGIC, INC.;C/O WARD AND SMITH, P.A., 1001 COLLEGE COURT, P.O. BOX 867, NEW BERN, NC, 28563-0867, US

(73) Assignee: ADVANCED LIQUID LOGIC, INC., Research Triangle Park, NC (US)

(21) Appl. No.: 12/531,826

(22) PCT Filed: Mar. 24, 2008
(86) PCT No.: PCT/US08/58047

§ 371 Date: Oct. 15, 2009

Related U.S. Application Data
(60) Provisional application No. 60/896,393, filed on Mar. 22, 2007.
(60) Provisional application No. 60/980,584, filed on Oct. 17, 2007.

(51) Int. Cl. C40B 30/00; C40B 50/08

(52) U.S. Cl. 506/7; 506/27

(57) ABSTRACT

A method of sorting beads on a droplet actuator. The method may, for example, include the following steps: (a) providing a droplet actuator comprising a substrate comprising electrodes arranged for conducting droplet operations on a substrate surface; (b) providing an assay droplet on the substrate surface, the droplet comprising two or more target-capture bead populations comprising target-capture beads comprising: (i) a capture probe bound to a target substance; and (ii) a unique bar binding element which binds to a corresponding binder; (c) using droplet operations to combine the assay droplet with a bead-capture droplet comprising one or more bead-capture beads having affinity for the binding element; (d) immobilizing the one or more bead-capture beads while conducting droplet operations to separate the bead-capture beads from unbound target-capture beads; (e) resuspending the one or more bead-capture beads in a droplet, thereby providing a droplet comprising a substantially pure substance-capture bead population; and (f) using droplet operations to conduct one or more protocol steps for an assay protocol.

### 2 RELATED PATENT APPLICATIONS

This patent application claims priority to U.S. Patent Application No. 60/896,393, filed on Mar. 22, 2007, entitled “Sample preparation by bead sorting”; and U.S. Patent Application No. 60/980,584, filed on Oct. 17, 2007, entitled “Bead sorting on a droplet actuator”; the entire disclosures of which are incorporated herein by reference.

### 1 GOVERNMENT INTEREST

This invention was made with government support under W81XWH-04-9-0019 awarded by HSARPA. The United States Government has certain rights in the invention.

### 3 BACKGROUND

Droplet actuators are used to conduct a wide variety of droplet operations. A droplet actuator typically includes a substrate comprising electrodes arranged for conducting droplet operations. The droplet actuator may also include a top plate separated from a droplet operations surface of the substrate to form a gap in which droplet operations may be effected The top plate may also include electrodes for conducting droplet operations. The space is typically filled with a filler fluid that is immiscible with the fluid that is to be manipulated on the droplet actuator. Surfaces exposed to the space are typically hydrophobic. There is a need in the art for droplet-based approaches for accurate and accelerated quantitation of multiple analytes, cells and/or other target substances in a sample. There is also a need for separating substances from a sample on a droplet actuator, e.g., for further analysis of the substance or a sub-component of the substance.

### 4 SUMMARY OF THE INVENTION

The invention provides a method of sorting beads on a droplet actuator. As an example, the method may involve one or more of the following steps: providing a droplet actuator comprising a substrate comprising electrodes arranged for conducting droplet operations on a substrate surface; providing an assay droplet on the substrate surface, the droplet comprising two or more target-capture bead populations comprising target-capture beads comprising: (a) a capture probe bound to a target substance, and (b) a unique binding element which binds to a corresponding binder; using droplet operations to combine the assay droplet with a bead-capture droplet comprising one or more bead-capture beads having affinity for the binding element; immobilizing the one or more bead-capture beads while conducting droplet operations to separate the bead-capture beads from unbound target-capture beads; resuspending the one or more bead-capture beads in a droplet, thereby providing a droplet comprising a substantially pure substance-capture bead population; and using droplet operations to conduct one or more protocol steps for an assay protocol.

In another embodiment, the invention provides a method of detecting multiple substances in a sample. In this embodiment, the method may generally include one or more of the following steps: providing a sample comprising two or more substances; providing two or more bead populations, wherein each population: (a) includes a capture probe having affinity for a target substance, and (b) is labeled with a unique binding element; combining the bead populations with the sample, thereby permitting each target substance to bind to its corresponding bead population; concentrating the beads and substantially separating the beads from the sample; loading the beads on a droplet actuator and conducting droplet operations to separate the bead populations into separate sets of one or more droplets per bead population.

In yet another embodiment, the invention provides a method of binding aa substance-capture bead to a bead-capture bead. In this embodiment, the method may generally include one or more of the following steps: providing a droplet actuator comprising a substrate comprising electrodes arranged for conducting droplet operations on a substrate surface; providing an assay droplet on the substrate surface, the assay droplet comprising substance-capture beads comprising: (a) a capture probe bound to a target substance, and (b) a unique binding element; using droplet operations to combine the assay droplet with a bead capture droplet comprising one or more bead-capture beads having affinity for the binding element; wherein one or more substance-capture beads bind to one or more bead capture beads in the droplet.

The method may also include conducting a droplet-based bead washing protocol, e.g., following the resuspending step. Moreover, the method may include pre-concentrating the substance-capture beads, e.g., prior to providing the assay droplet.

In certain embodiments, the binding element may include a single stranded nucleic acid molecule, and the binder may include a corresponding reverse complement single stranded nucleic acid molecule.

In some cases, the bead-capture beads are magnetically responsive; and the immobilizing step involves immobilizing the bead-capture beads using a magnetic field. In other cases immobilizing the bead-capture beads involves using a physical barrier which blocks movement of beads while permitting fluid to be transported away from the beads.

The target substance may be an analyte or may include an analyte. In some cases, the target substance is a cell or includes a cell.

The droplets may in some cases be partially or substantially surrounded by a filler fluid. In some embodiments, the filler fluid may include or consist of a gaseous filler fluid. In other cases, the filler fluid may include or consist of an oil.

The invention also provides a method of separating magnetically responsive beads from substantially non-magnetically responsive beads on a droplet actuator. In this embodiment, the method may generally include one or more of the following steps: providing a droplet actuator comprising a substrate comprising electrodes arranged for conducting droplet operations on a substrate surface; providing a droplet on the substrate surface comprising: (a) one or more magnetically responsive beads, and (b) one or more substantially non-magnetically responsive beads; using a magnetic field to immobilize the magnetically responsive beads; conducting droplet operations to separate the substantially non-magnetically responsive beads from the immobilized magnetically responsive beads.

In some cases, a portion or all of the substantially non-magnetically responsive beads have an analyte bound thereto. In some cases, a portion or all of the magnetically responsive beads have an analyte bound thereto. In some cases, a portion or all of the substantially non-magnetically responsive beads have a biological cell bound thereto. In some cases, a portion or all of the magnetically responsive beads have a biological cell bound thereto.

### 5 DEFINITIONS

As used herein, the following terms have the meanings indicated.

“Activate” with reference to one or more electrodes means effecting a change in the electrical state of the one or more electrodes which results in a droplet operation.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical and other three dimensional shapes. The bead may, for example, be capable of being transported in a droplet on a droplet actuator; configured with respect to a droplet actuator in a manner which permits a droplet on the droplet actuator to be brought into contact with the bead, on the droplet actuator and/or off the droplet actuator. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead or one component only of a bead. The remainder of the bead may include, among other things, polymeric material, coatings, and moieties which permit attachment of an assay reagent. Examples of suitable magnetically responsive beads are described in U.S. Patent Publication No. 2005-0260686, entitled, “Multiplex flow assays preferably with magnetic particles as solid phase,” published on Nov. 24, 2005, the entire disclosure of which is incorporated herein by reference for its teaching concerning magnetically responsive materials and beads. It should also be noted that various droplet operations described herein which can be conducted using beads can also be conducted using biological cells.

“Droplet” means a volume of liquid on a droplet actuator which is at least partially bounded by filler fluid. For example, a droplet may be completely surrounded by filler fluid or may be bounded by filler fluid and one or more surfaces of the droplet actuator. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet actuator.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to size of the resulting droplets (i.e., the size of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading.

“Immobilize” with respect to magnetically responsive beads, means that the beads are substantially restrained in position in a droplet or in filler fluid on a droplet actuator. For example, in one embodiment, immobilized beads are sufficiently restrained in position to permit execution of a spiltting operation on a droplet, yielding one droplet with substantially all of the beads and one droplet substantially lacking in the beads.

“Magnetically responsive” means responsive to a magnetic field. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Washing” with respect to washing a magnetically responsive bead means reducing the amount of one or more substances in contact with the magnetically responsive bead or exposed to the magnetically responsive bead from a droplet in contact with the magnetically responsive bead. The reduction in the amount of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial total amount of a substance. The washing operation may proceed using a variety of droplet operations. The washing operation may yield a droplet including the magnetically responsive bead, where the droplet has a total amount of the substance which is less than the initial amount of the substance. Other embodiments are described elsewhere herein, and still others will be immediately apparent in view of the present disclosure.

The terms “top” and “bottom” are used throughout the description with reference to the top and bottom substrates of the droplet actuator for convenience only, since the droplet actuator is functional regardless of its position in space.

When a given component such as a layer, region or substrate is referred to herein as being disposed or formed “on” another component, that given component can be directly on the other component or, alternatively, intervening components (for example, one or more coatings, layers, interlayers, electrodes or contacts) can also be present. It will be further understood that the terms “disposed on” and “formed on” are used interchangeably to describe how a given component is positioned or situated in relation to another component. Hence, the terms “disposed on” and “formed on” are not intended to introduce any limitations relating to particular methods of material transport, deposition, or fabrication.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct droplet operations on the droplet, the droplet is arranged on the droplet actuator in a manner which facilitates sensing of a property of or a signal from the droplet, and/or the droplet has been subjected to a droplet operation on the droplet actuator.

### 6 DESCRIPTION

The present invention provides a systems, devices and methods for separation of target substances from a sample. The invention also provides for accurate and accelerated detection and quantitation of multiple target substances in a sample, using a droplet actuator.

6.1 Bead Sorting on a Droplet Actuator

The invention provides a method of separating multiple substances in a sample and/or detecting multiple target substances in a sample. The sample is reacted with multiple bead populations. Each bead population specifically binds to, or interacts with, a unique substance, such as a cell or a molecule. For example, a bead population may interact with a unique target substance due to the presence of an antibody on the surface of the bead, wherein the antibody specifically binds to the unique target substance. Each unique bead population may be specifically removed from the sample. For example, each unique bead population may be labeled with a ‘bar code’, such as single stranded DNA. The ‘bar code’ may allow for the unique bead population to be removed from the sample, such as by the specific interaction with magnetically responsive beads. The removed beads may be assayed to characterize and/or quantify the amount of target substance present in the sample.

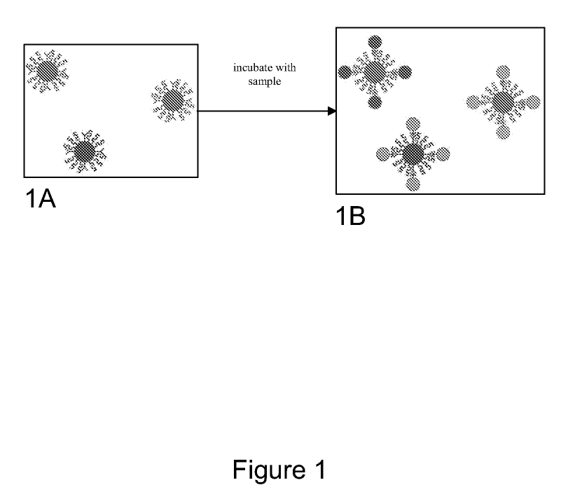

FIG. 1 provides a schematic illustrating three different target-capture bead populations incubated with a sample. Analytes, cells and/or other target substances in the sample specifically bind to a corresponding unique target-capture bead population. As illustrated in FIG. 1A, each target-capture bead carries a specific target-capture probe, i.e. the target-capture beads in one population carry a particular target-capture probe, the beads in a second target-capture population carry a different target-capture probe, etc. As illustrated in FIG. 1B, upon incubation with the sample, each target-capture bead population captures the target substance in the sample that correspond to the particular target-capture probe. Subsequent to the incubation, some or all of the target substances are bound to the target-capture beads.

In one embodiment, the amount of beads carrying capture probe is much greater than the amount of target substance to be captured from the sample. In another embodiment, the amount of capture probe provided collectively in a bead population is substantially greater than the amount of target substance expected to be captured from the sample.

The target-capture beads combined with the sample may be concentrated and separated from the remaining sample. The separation may, for example, be effected by centrifugation, filtration, reversible binding, etc. Following separation, the target-capture beads may be further processed, for example, by suspending the beads in buffer solution, washing the beads, etc. The target-capture beads may also be separated into aliquots as needed.

The steps illustrated in FIG. 1 may be carried out using a variety of common techniques, e.g., they may be carried out in a test tube or in a microarray. Alternatively, these steps may be effected in droplets on a droplet actuator. In one embodiment, these steps and subsequent steps are effected using droplet operations in a droplet actuator. In another embodiment, these steps are accomplished off the droplet actuator, and subsequent steps are accomplished using droplet operations in a droplet actuator.

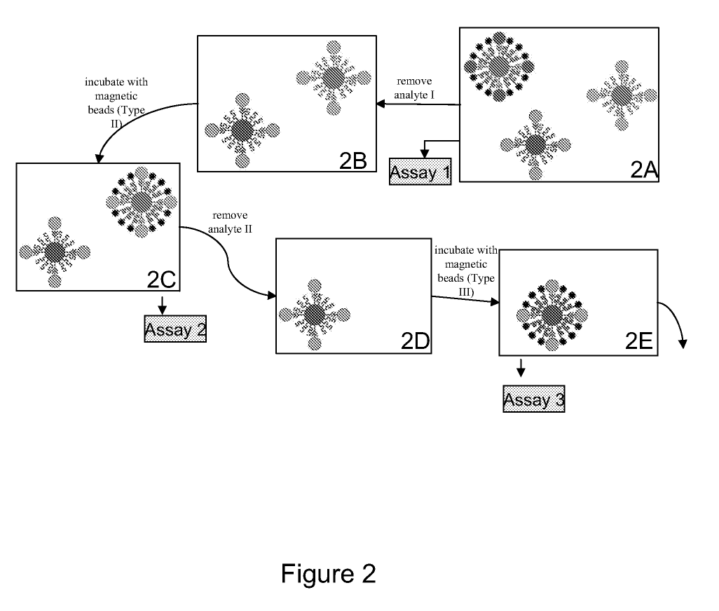

FIG. 2 illustrates a sorting procedure for using droplet operations to separate target-capture bead populations. In general, the method includes sequentially incubating a droplet comprising multiple target-capture bead populations with one or more bead-capture beads having a specific affinity for a target substance. During incubation, the target-capture beads of the target population bind to the bead-capture beads. The bead-capture beads can then be immobilized, e.g., using magnetic fields and/or physical barriers, while the remaining bead populations are removed using droplet operations. The bead-capture beads bound to their target target-capture beads can then be subjected to further droplet operations as required to complete an assay protocol.

FIG. 2 depicts in Panel 2A three populations of target-capture beads bound to their target substances, and one of the populations of target-capture beads also bound to bead capture beads. Using droplet operations, the bead-capture beads with their associated target-capture beads can be separated from the unbound target-capture beads, providing one or more droplets with a substantially pure population of bead-capture beads. This set of one or more droplets can be used for conducting one or more steps required to identify and/or quantify target target-captured by the associated target-capture beads. Any droplets including unbound target-capture beads (Panel 2B) can be merged with further bead-capture droplets having bead-capture beads, followed by immobilization, splitting, and washing as needed to isolate another population of bead-capture beads. The process can be repeated as necessary until all populations of target-capture beads have been isolated (Panels 2B, 2C, 2D, 2E).

Bead-capture beads can be immobilized while droplet operations are used to transport away some portion or all of the surrounding droplet including the target-capture beads. A droplet-based washing protocol may be used to remove the bead capture beads from the target-capture beads. Alternatively, the droplet may remain in place while a magnetic force is used to remove magnetically responsive bead-capture beads from the droplet.

As already noted, each target-capture bead contains a unique bar code molecule. The method makes use of surfaces that have a specific affinity for the unique bar code molecule. For example, the surface may be another bead, such as the bead-capture beads already described, and/or a surface of the droplet actuator itself. The approach permits identification of the target-capture bead population independent of the specificity of the capture probe.

The bar code may be a molecule which specifically binds to another molecule. For example, the bar code may include a single stranded nucleic acid molecule, which binds to a corresponding reverse complement single stranded nucleic acid molecule, e.g., a single stranded DNA molecule, which binds to a corresponding reverse complement single stranded DNA molecule. Alternatively, the bar code/complimentary molecule combination may include antibody/antigen combination, a receptor/ligand combination and/or a variety of chemical approaches.

In some cases, the volume of the mixture of target-capture bead populations may be too large for droplet operations in single droplet. In such cases, the bead-capture surface may be serially exposed to multiple aliquots of target-capture beads. For example, an on-chip reservoir may be loaded with an aliquot of target-capture beads including multiple target-capture bead populations. Using droplet operations, sub-droplets can be dispensed from the reservoir, and each sub-droplet can be transported into contact with the bead-capture surface. For example, if the bead-capture surface includes a surface of the droplet actuator, the sub-droplets may be serially transported across the bead capture surface. Or, if the bead-capture surface includes magnetically responsive bead-capture beads, then the bead-capture beads can be exposed to each sub-droplet. One way to achieve this exposure makes use of the following steps:
1. Combining a bead-capture droplet having magnetically responsive bead-capture beads with one or more of the sub-droplets;
2. Immobilizing the magnetically responsive bead-capture beads and conducting a spitting operation to remove some portion of the droplet including unbound target-capture beads; and
3. Resuspending the magnetically responsive beads and repeating the process beginning at step 1 with a new sub-droplet until the desired quantity of sub-droplets has been exposed to the magnetically responsive bead-capture beads.

In this manner, each of the sub-droplet aliquots may be exposed to a population of magnetically responsive bead-capture beads. Further, the splitting operation in step 2 yields an aliquot droplet that can be exposed to another population of magnetically responsive bead-capture beads. Thus, the process can be repeated for a series of magnetically responsive bead-capture beads, so that all target-capture beads in the starting sample have an opportunity to be captured by a corresponding bead-capture bead population.

In a further aspect of the invention, the order of exposure of the aliquots of target-capture beads to each bead-capture surface may be randomized or otherwise relatively evenly distributed among bead-capture surfaces. In other words, if there are five bead-capture surfaces, 1, 2, 3, 4, 5, then a first aliquot might be exposed to the surfaces in the order 1, 2, 3, 4, 5; a second aliquot may be exposed in the order 2, 3, 4, 5, 1; a third aliquot may be exposed in the order 3, 4, 5, 1, 2. Any pattern may be used which relatively evenly distributes the order of exposure, or a random exposure pattern may be used.

Following the substantial or complete isolation of a particular bead-capture bead population in a droplet, one or more additional droplet operations may be conducted to analyze the target substance. The assay may result in the identification of and/or quantitation of the target substance.

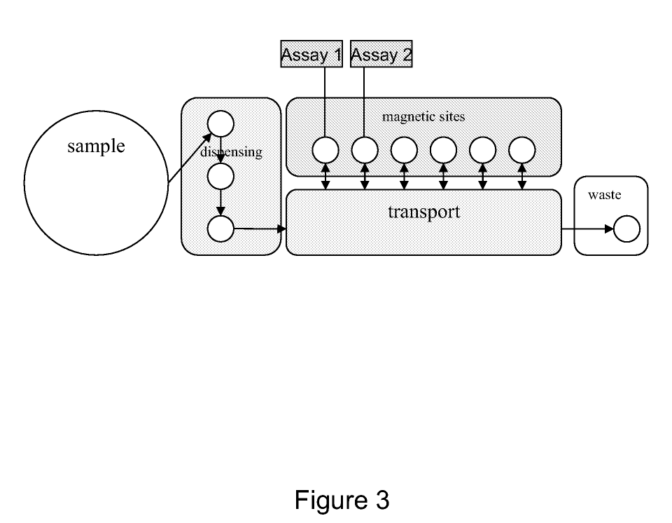

FIG. 3 provides a schematic illustrating functional components of a droplet actuator used to carry out the methods of the invention. The droplet actuator may include a sample reservoir. The sample reservoir may function to which functions to accept and dispense sample onto the droplet actuator. For example, the droplet actuator may include a substrate with a sample reservoir and electrodes arranged so that droplets can be dispensed from the sample reservoir onto the electrodes for conducting droplet operations. The droplet actuator also includes electrodes for transporting droplets and conducting other droplet operations as required for conducting a specific assay protocol. Further, where magnetically responsive beads are used, the droplet actuator may include a source of a magnetic field for immobilizing magnetically responsive beads during washing operations, sample exposure operations and the like. The droplet actuator may also include a waste reservoir for depositing droplets no longer required for assays, such as used wash droplets.

6.2 Sample Preparation

Where the target substances are present in a large sample, pre-concentration of the target substance may be required prior to conducting a droplet-based assay protocol. Various embodiments may, for example, make use of magnetically responsive common binding beads with common binding elements and target-capture beads having a binder for the common binding element. The common binding beads may be used to aggregate the target-capture beads in a large sample. A magnetic field may be used to aggregate the common binding beads. The beads may be washed, and the target-capture beads may be released for loading onto a droplet actuator.

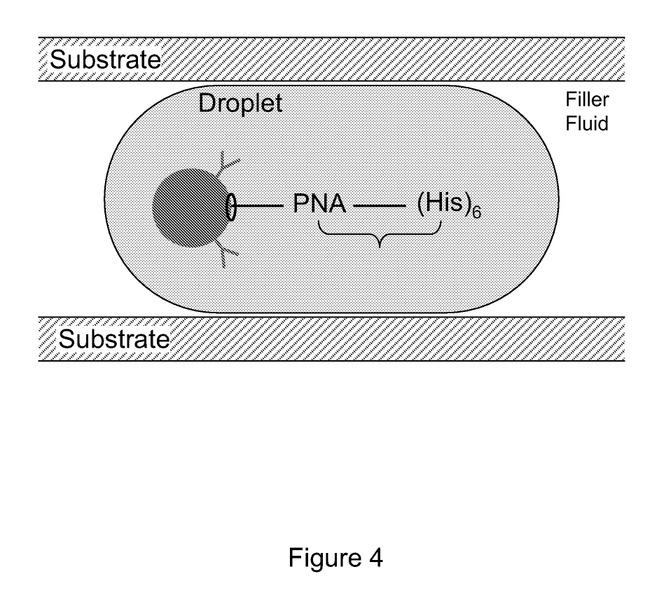

FIG. 4 illustrates a modified bead designed to provide for separating the target-capture beads from the sample volume. After incubation of the target-capture beads with the original sample, it may be desirable to decrease the volume and concentrate the target-capture beads. Centrifugation or filtration methods may be useful for this concentration step. An embodiment of the invention relates to the use of a common reversible binder for the concentration step. A common binding determinant, such as (His)₆, may be present on beads, referred to here as “common binding beads,” for effecting this concentration step. The common binding determinant may, for example, be coupled to a bead through a PNA (polyamide nucleic acid, also termed protein or peptide nucleic acid) or DNA linker.

In one aspect of the invention, the magnetically responsive common binding beads may be incubated with target-capture beads that include a molecule that binds the common binding determinant to provide a [common binding bead]-[target-capture bead] combination. A magnetic field source can be used to immobilize the [common binding bead]-[target-capture bead] combination. The magnetic field source may be located on a droplet actuator for capturing the magnetically responsive beads, e.g., as described in U.S. Patent Application No. 60/980,529, filed on Oct. 17, 2007, by Pamula et al., entitled “Pre-concentration of target substance on a droplet actuator,” the entire disclosure of which is incorporated herein by reference.

The [common binding bead]-[target-capture bead] may then be washed as needed, e.g., using a droplet-based surface or bead washing protocol on a droplet actuator. The binder/common binding determinant interaction may then be disrupted to leave the concentrated target-capture bead available for further processing, e.g., for separating out populations of target-capture beads as described above in droplet based protocols. Various reversible binding determinant/binder combinations are usefully employed, such polyhistidine-tag/bound metal ions (e.g., nickel or cobalt) to which the polyhistidine-tag binds, or biotin/streptavidin.

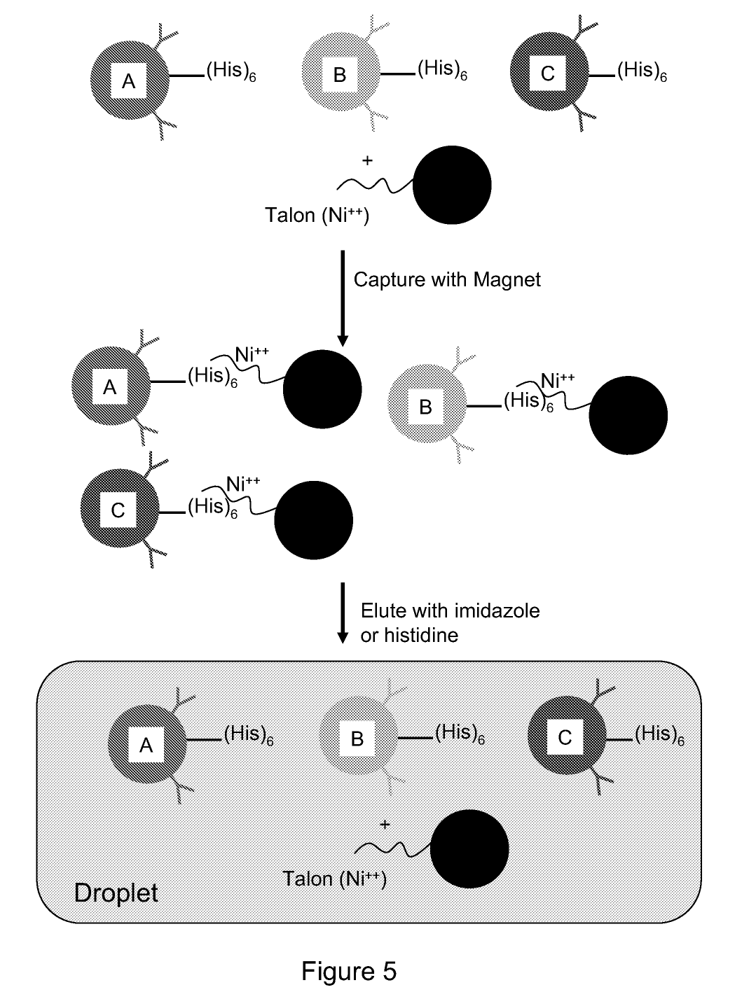

FIG. 5 illustrates a method of concentrating the target-capture beads using a common binding determinant. The unique target-capture bead populations also carry a common binding determinant, such as (His)₆. The beads are incubated with magnetically responsive common binding beads, carrying a binder of the common binding determinant, such as Ni^{||}. The common binding determinant/binder interaction causes the target-capture beads to be bound to the magnetically responsive common binding beads. The solution is exposed to a magnetic field, resulting in the capture of the target-capture beads bound to the magnetically responsive common binding beads. Some portion or all of the sample solution is removed, resulting in concentrated target-capture beads bound to magnetically responsive common binding beads. The binding determinant/binder interaction is disrupted, for example by the addition of imidazole or histidine. The magnetically responsive common binding beads may be immobilized by a magnetic field, and the concentrated target-capture beads may be removed for loading on the droplet actuator.

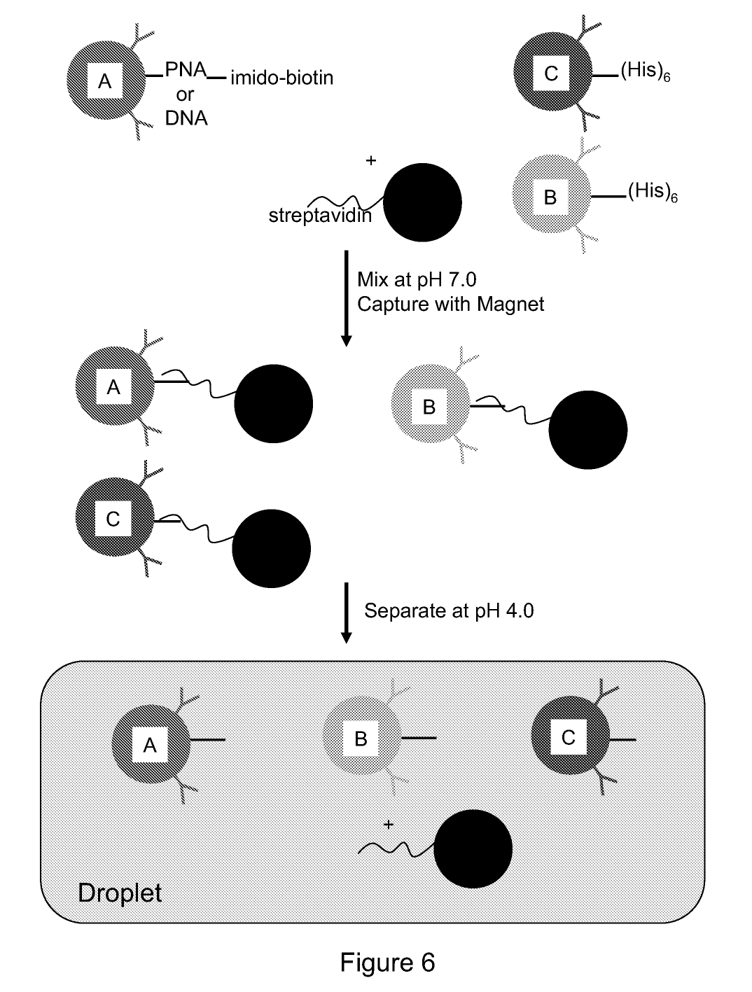

FIG. 6 illustrates a method of concentrating target-capture beads using a common binding determinant, in which the common binding determinant is imido-biotin, and the disruption results from exposure to pH 4.0. As described above, the unique target-capture bead populations carry a common binding determinant, such as imido-biofin. Although biotin may be used, its interaction with its binder streptavidin is very strong. In contrast, the interaction of imido-biotin with streptavidin can be disrupted under gentle treatment conditions. The target-capture beads are incubated with magnetically responsive common binding beads, carrying a binder of the common binding determinant, such as streptavidin, under conditions appropriate for binding, such as pH 7.0. Through the common binding determinant/binder interaction, the target-capture beads are bound to the magnetically responsive common binding beads. The solution is exposed to a magnet, resulting in the capture of the target-capture beads bound to the magnetically responsive common binding beads. Some or all of the sample solution is removed, resulting in concentrated target-capture beads bound to magnetically responsive common binding beads beads. The binding determinant/binder interaction is disrupted, for example at pH 4.0. The disruption of the binding may be reversible, as illustrated in this embodiment. The magnetically responsive common binding beads remain bound to the magnet, and the concentrated target-capture beads are removed for loading onto the droplet actuator.

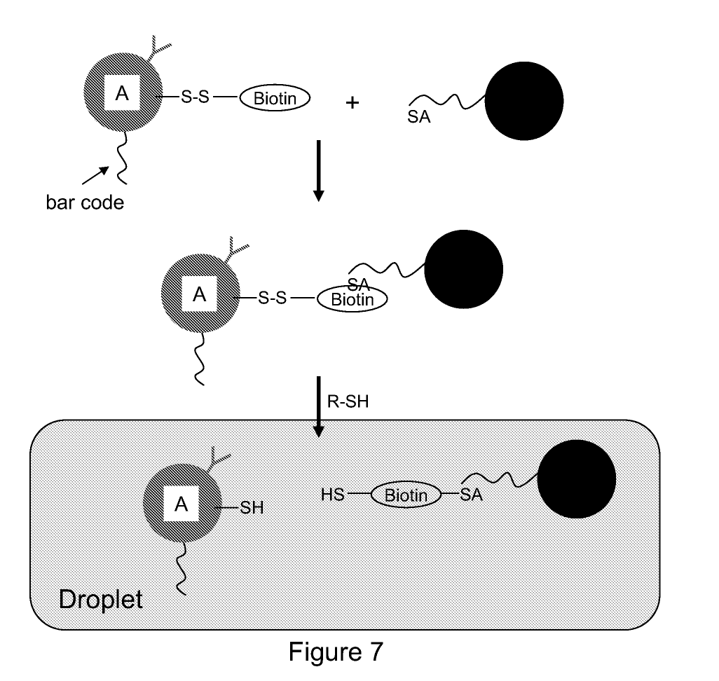

FIG. 7 illustrates a common binding element/binder pair, in which the common binding element is coupled to the target-capture bead through a chemical interaction. The common binding element, biotin, is bound to the target-capture bead by a disulfide bond. The magnetically responsive bead carries the corresponding binder, streptavidin. As above, the magnetically responsive bead binds the target-capture bead through the common binding element/binder interaction, the beads are concentrated by use of a magnet, and the supernatant solution is removed. In this embodiment, instead of disrupting the common binding element/binder interaction, the common binding element is removed from the target-capture bead. The exposure of the sample to a thiol results in the disruption of the disulfide bond, resulting in the removal of the common binding element from the sample bead. FIG. 7 illustrates an embodiment in which a disulfide bond is used to couple the common binding element to the target-capture beads, and the bond is disrupted by the addition of a thiol; however, other attachment chemistries are contemplated. For example, a vicinal hydroxyl linker may be used to attach the common binding element to the target-capture bead, and the bond may be disrupted by the addition of periodate.

6.3 Droplet Actuator

For examples of droplet actuator architectures suitable for use with the present invention, see U.S. Pat. No. 6,911,132, entitled “Apparatus for Manipulating Droplets by Electrowetting-Based Techniques,” issued on Jun. 28, 2005 to Pamula et al.; U.S. patent application Ser. No. 11/343,284, entitled “Apparatuses and Methods for Manipulating Droplets on a Printed Circuit Board,” filed on filed on Jan. 30, 2006; U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000, both to Shenderov et al.; Pollack et al., International Patent Application No. PCT/US 06/47486, entitled “Droplet-Based Biochemistry,” filed on Dec. 11, 2006, the disclosures of which are incorporated herein by reference. Methods of the invention may be executed using droplet actuator systems, e.g., as described in International Patent Application No. PCT/US2007/09379, entitled “Droplet manipulation systems,” filed on May 9, 2007. Examples of droplet actuator techniques for immobilizing magnetic beads and/or non-magnetic beads are described in the foregoing international patent applications and in Sista, et al., U.S. Patent Application Nos. 60/900,653, filed on Feb. 9, 2007, entitled “Immobilization of magnetically-responsive beads during droplet operations”; Sista et al., U.S. Patent Application No. 60/969,736, filed on Sep. 4, 2007, entitled “Droplet Actuator Assay Improvements”; and Allen et al., U.S. Patent Application No. 60/957,717, filed on Aug. 24, 2007, entitled “Bead washing using physical barriers,” the entire disclosures of which is incorporated herein by reference.

6.4 Reagents and Samples

For examples of sample fluids usefully employed according to the approach of the invention, see the patents listed in section 6.3, especially International Patent Application No. PCT/US2006/47486, entitled “Droplet-Based Biochemistry,” filed on Dec. 11, 2006. In some embodiments, the fluid includes a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, fluidized tissues, fluidized organisms, biological swabs and biological washes.

6.5 Filler Fluids

The gap will typically be filled with a filler fluid. The filler fluid may, for example, be a low-viscosity oil, such as silicone oil. Other examples of filler fluids are provided in International Patent Application No. PCT/US 06/47486, entitled “Droplet-Based Biochemistry,” filed on Dec. 11, 2006.

This specification is divided into sections for the convenience of the reader only. Headings should not be construed as limiting of the scope of the invention.

It will be understood that various details of the present invention may be changed without departing from the scope of the present invention. Various aspects of each embodiment described here may be interchanged with various aspects of other embodiments. Furthermore, the foregoing description is for the purpose of illustration only, and not for the purpose of limitation.

We claim:

1. A method of sorting beads on a droplet actuator, the method comprising:
(a) providing a droplet actuator comprising a substrate comprising electrodes arranged for conducting droplet operations on a substrate surface;
(b) providing an assay droplet on the substrate surface, the droplet comprising two or more target-capture bead populations comprising target-capture beads comprising:
(i) a capture probe bound to a target substance; and
(ii) a unique binding element which binds to a corresponding binder;
(c) using droplet operations to combine the assay droplet with a bead-capture droplet comprising one or more bead-capture beads having affinity for the binding element;
(d) immobilizing the one or more bead-capture beads while conducting droplet operations to separate the bead-capture beads from unbound target-capture beads;
(e) resuspending the one or more bead-capture beads in a droplet, thereby providing a droplet comprising a substantially pure substance-capture bead population; and
(f) using droplet operations to conduct one or more protocol steps for an assay protocol.

2. The method of claim 1 further comprising conducting a droplet-based bead washing protocol following step 1(e).

3. The method of claim 1 further comprising pre-concentrating the substance-capture beads prior to step 1(b).

4. The method of claim 1 wherein the binding element comprises a single stranded nucleic acid molecule, and the binder comprises a corresponding reverse complement single stranded nucleic acid molecule.

5. The method of claim 1 wherein:
(a) the bead-capture beads are magnetically responsive; and
(b) step 1(d) comprises immobilizing the bead-capture beads using a magnetic field.

6. The method of claim 1 wherein step 1(d) comprises immobilizing the bead-capture beads using a physical barrier which blocks movement of beads while permitting fluid to be transported away from the beads.

7. The method of claim 1 wherein the target substance comprises an analyte.

8. The method of claim 1 wherein the target substance comprises a cell.

9. A method of detecting multiple substances in a sample, the method comprising:
(a) providing a sample comprising two or more substances;
(b) providing two or more bead populations, wherein each population:
(i) comprises a capture probe having affinity for a target substance; and
(ii) is labeled with a unique binding element;
(c) combining the bead populations with the sample, thereby permitting each target substance to bind to its corresponding bead population;
(d) concentrating the beads and substantially separating the beads from the sample;
(e) loading the beads on a droplet actuator and conducting droplet operations to separate the bead populations into separate sets of one or more droplets per bead population.

10. The method of claim 9 wherein the target substance comprises an analyte.

11. The method of claim 9 wherein the target substance comprises a cell.

12. A method of binding a substance-capture bead to a bead-capture bead, the method comprising:
(a) providing a droplet actuator comprising a substrate comprising electrodes arranged for conducting droplet operations on a substrate surface;
(b) providing an assay droplet on the substrate surface, the assay droplet comprising substance-capture beads comprising:
(i) a capture probe bound to a target substance; and
(ii) a unique binding element;
(c) using droplet operations to combine the assay droplet with a bead capture droplet comprising one or more bead-capture beads having affinity for the binding element;
wherein one or more substance-capture beads bind to one or more bead capture beads in the droplet.

13. The method of claim 12 wherein the droplet is partially surrounded by a filler fluid.

14. The method of claim 12 wherein the droplet is substantially surrounded by a filler fluid.

15. The method of claim 12 wherein the target substance comprises an analyte.

16. The method of claim 12 wherein the target substance comprises a cell.

17. The method of claim 13 wherein the filler fluid comprises a gaseous filler fluid.

18. The method of claim 13 wherein the filler fluid comprises an oil.

19. A method of separating magnetically responsive beads from substantially non-magnetically responsive beads on a droplet actuator, the method comprising:
(a) providing a droplet actuator comprising a substrate comprising electrodes arranged for conducting droplet operations on a substrate surface;
(b) providing a droplet on the substrate surface comprising:
(i) one or more magnetically responsive beads; and
(ii) one or more substantially non-magnetically responsive beads;
(c) using a magnetic field to immobilize the magnetically responsive beads;
(d) conducting droplet operations to separate the substantially non-magnetically responsive beads from the immobilized magnetically responsive beads.

20. The method of claim 19 wherein the substantially non-magnetically responsive beads comprise an analyte bound thereto.

21. The method of claim 19 wherein the magnetically responsive beads comprise an analyte bound thereto.

22. The method of claim 19 wherein the substantially non-magnetically responsive beads comprise a biological cell bound thereto.

23. The method of claim 19 wherein the magnetically responsive beads comprise a biological cell bound thereto.
